(19) United States
(12) Patent Application Publication
(10) Pub. No.: US 2002/0133811 A1
(43) Pub. Date: Sep. 19, 2002

(54) Bean scripting components

(76) Inventors: Matthew J. Duftler, Tarrytown, NY (US); Rania Y. Khalaf, Beirut (LB); Joseph J. Kesselman, Ossining, NY (US); Sanjiva Weerawarana, Yorktown Heights, NY (US)

Correspondence Address: McGuire Woods, LLP, Tysons Corner, Suite 1800, 1750 Tysons Boulevard, McLean, VA, 22102-3915, US

(21) Appl. No.: 09/735,942

(22) Filed: Dec. 14, 2000

(51) Int. Cl. G06F 9/45

(52) U.S. Cl. 717/140

(57) ABSTRACT

Bean Scripting Components (BSC) is an eXtensible Markup-based (XML-based) language for defining and implementing JavaBeans components using any scripting language. The BSC language provides a first-class syntax for describing a JavaBeans component's properties, events and methods. JavaBeans components can be defined and implemented using any programming language that compiles to a Java class. Once compiled into Java, a BSC defined JavaBeans component is compatible with any other JavaBeans component implemented directly in Java itself.

### CROSS-REFERENCE TO RELATED APPLICATION

The subject matter of this application is related to that of U.S. patent application Ser. No. 09/425,726 filed Oct. 22, 1999, by Sanjiva Weerawarana and Matthew J. Duftler for “Bean Scripting Framework”, and assigned to a common assignee herewith. The disclosure of application Ser. No. 09/425,726 is incorporated herein by reference.

### DESCRIPTION

### BACKGROUND OF THE INVENTION

1. Field of the Invention

The present invention generally relates to providing a language for defining and implementing JavaBeans components and, more particularly, to an extensible Markup Language-based (XML-based) language for defining and implementing JavaBeans components using any scripting language or languages.

2. Background Description

The Java platform and its JavaBeans component architecture presents a powerful environment upon which to practice component-oriented software development. The JavaBeans component architecture provides a well-defined component model and execution environment for component-oriented programming. While any Java class can be considered to be a JavaBeans component, some components may be richer in function than others.

JavaBeans components can be defined and implemented using any programming language that compiles to a Java class. However, these languages, including Java itself, typically do not provide first class support at the language level for key JavaBeans component attributes such as properties, events and methods. The programming approach supported by these languages is to define an arbitrary class and then use an auxiliary BeanInfo class to provide the meta information about the JavaBeans component provided by the class. The bean information may also be automatically generated at run-time by introspection.

Scripting languages are playing an increasing role in enabling component-oriented programming. While these languages play a key role at the component composition level, there is currently almost no support for defining new JavaBeans components using scripting languages.

Interface Design Languages (IDLs) are well known, as are compilers that will render and IDL as a framework for an executable class. Some IDLs, such as Common Object Request Broker Architecture (CORBA), do imply programming conventions. There exists a need for an IDL that is tailored to the JavaBeans conventions. There is also a need for an IDL that bridges to user-written executable code.

### SUMMARY OF THE INVENTION

It is therefore an object of the present invention to provide a language for defining and implementing JavaBeans components using any scripting language or languages.

According to the invention, there is provided an IDL, here referred to as Bean Scripting Components (BSC), which combines two concepts:

1) BSC directly expresses the concepts of JavaBeans programming conventions. This both eases and encourages conformance to this component-software design practice.

2) BSC allows code fragments (in a variety of languages, not just Java) to be used to specify behaviors of these interfaces.

BSC is an XML-based language for defining and implementing JavaBeans components using any scripting language. The BSC language provides a first-class syntax for describing a JavaBeans component's properties, events and methods, and for expressing software object classes as components, which are in turn made up of constructors, properties, methods, and events as defined by Sun Microsystem's JavaBeans programming conventions. A JavaBeans component's function is expressed in terms of three attributes: its properties, any events it may generate during execution, and public methods. Properties may be read-only, write-only or read-write. Events are delivered to target listener objects which register themselves at the event source component. A component may also have public methods which can be used to interact with the component in other ways.

BSC documents can be compiled into a Java class using the BSC Compiler. Once compiled into Java, a BSC defined JavaBeans component is 100% compatible with any other JavaBeans component implemented directly in Java itself. The BSC compiler can automatically re-express these in terms of the lower-level Java code that implements them. For example, a property is typically made up of some combination of field, setter method, and getter method. The exact combination and details will depend upon the declared characteristics of that property. Letting the user work with higher-level concepts both eases their task by generating standard code for them, and discourages violation (deliberate or inadvertent) of the JavaBean conventions.

The properties and events of a component are represented in the component's Java class as public methods. The JavaBeans specification defines certain design patterns (naming conventions) for public methods so that a JavaBeans component's attributes can be automatically deduced from its Java class by a process known as “Introspection”. A JavaBeans component author may also optionally author a BeanInfo class for the component in order to explicitly control exactly the attributes of the component. If a BeanInfo for a component is missing, then introspection is used to infer the components' attributes. When a BeanInfo is present the BeanInfo class fully describes the component's attributes. In particular, this allows a component author to, for example, select only a few of the public methods of the Java class to be public methods of the component.

Automatically generated code is not sufficient to allow complete implementation of a class. It is necessary to hard code the detailed programmatic behaviors that make this class more than just data storage. While it would be possible to use BSC just to generate a framework, and then fill the coding details by hand, it would be preferable to allow users to express these behaviors as annotations upon the BSC source code. This has been done by letting BSC take advantage of the Bean Scripting Framework (BSF), disclosed in co-pending application Ser. No. 09/425,726, which provides the additional benefit of allowing BSC to produce Java classes with non-Java methods, without requiring that users understand the details of BSF invocation. As a result, BSC also serves as a user-friendly front end to BSF.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a flow chart illustrating the semantics of the <bsc:component> element;

FIG. 2 is a flow chart expanding the “configure class” function block of the flow chart of FIG. 1;

FIG. 3 is a flow chart illustrating the semantics of the <bsc:constructor> element of the flow chart of FIG. 2;

FIGS. 4A to 4C, taken together, are a flow chart illustrating the semantics of the <bsc:property> element of the flow chart of FIG. 2;

FIGS. 5A to 5C, taken together, are a flow chart illustrating the semantics of the <bsc:method> element of the flow chart of FIG. 2;

FIG. 6 is a flow chart illustrating the semantics of the <bsc:parameter> element of the flow chart of FIG. 5;

FIG. 7 is a flow chart illustrating the semantics of the <bsc:event> element of the flow chart of FIG. 2;

FIG. 8 is a flow chart illustrating the semantics of the <bsc:script> element of the flow chart of FIGS. 4 and 5;

FIGS. 9A to 9C, taken together, are a flow chart illustrating the <bsc:field> elements that can be used in the <bsc:property> and <bsc:unpublished> elements shown in FIG. 1; and

FIG. 10 is a flow chart illustrating the semantics of the <bsc:unpublished> element of FIG. 2.

### DETAILED DESCRIPTION OF A PREFERRED EMBODIMENT OF THE INVENTION

In this document the terms “bean” and “component” are used synonymously to refer to a JavaBeans component.

The BSC language is an XML vocabulary, using XML namespaces as defined in the 1999 World Wide Web Consortium (W3C) Recommendation “Namespaces in XML”. The Namespaces specification allows authors to mix two or more XML-based languages in one document without conflict or ambiguity, thus promoting the modular development and reuse of XML languages and applications. It achieves this by allowing element and attribute names to be bound (implicitly or via a declared prefix) to a specific URI that functions as the namespace's name. XML-based applications can follow this chain from prefix to namespace name to determine which namespace, and hence which language, should govern the interpretation of this part of the document.

The unique URI that identifies the initial version of the BSC language is “http://www.research.ibm.com/namespaces/1999/bsc” Per the SML Namespaces specification, a namespace declaration attribute with this URI must appear in the document at or before the first element in which it is referenced, either as the default namspace:

xmlns=“http://www.research.ibm.com/namespaces/1999/bsc” or with an explicit prefix, which must then be used to form the Qualified Names of the elements and attributes. In this document, the prefix “bsc” is always used, and the following namespace declaration mut be in scope for it to be interpreted as referring to the BSC language:

xmlns:bsc=“http://www.research.ibm.com/namespaces/1999/bsc” It should be understood by those skilled in the art that the prefix choice is entirely arbitrary, and that setting the default namespace is a perfectly reasonable alternative.

The following table provides a brief description of the BSC language elements, assuming (as we have just discussed) that the prefix “bsc” has been bound to the correct namespace URI:

| Element | Description |
|---|---|
| <bsc:component> | Define a new bean |
| <bsc:constructor> | Define the bean’s constructor |
| <bsc:property> | Define a property for the bean |
| <bsc: setter> | Define a setter method for a property |
| <bsc:getter> | Define a getter method for a property |
| <bsc:method> | Define a method for the bean |
| <bsc:param> | Define a parameter of a method |
| <bsc:event> | Define an event that the bean will fire |
| <bsc:script> | Define the body of a method using a scripting |
| | language |
| <bsc:field> | Define a field in the class being created |
| <bsc:unpublished> | Used to contain parts of the bean that are not |
| | exposed via its BeanInfo |

Compiling a <bsc:component> element with the BSC compiler results in the appropriate Java sources and classes to represent the bean described by the <bsc:component> element. If a BeanInfo class is required to properly represent the bean by the generated Java class, it will be generated as well. (A BeanInfo may optionally be generated for cases where it is not essential as well.) In the following sections, the semantics of each of the elements is given in terms of the class that is generated by the compiler.

### Component Definition

The <bsc:component> element is used to define a new bean. The BSC tools process <bsc:component> elements. As Java classes, beans may extend other classes and implement interfaces.

It should be noted that, in the following description, we are reporting errors when required data is missing or incorrect, but not when additional data may be present. If desired, stricter constraints may be applied, e.g., by validating the BSC source file against an appropriate DTD or XML Schema before compilation begins.

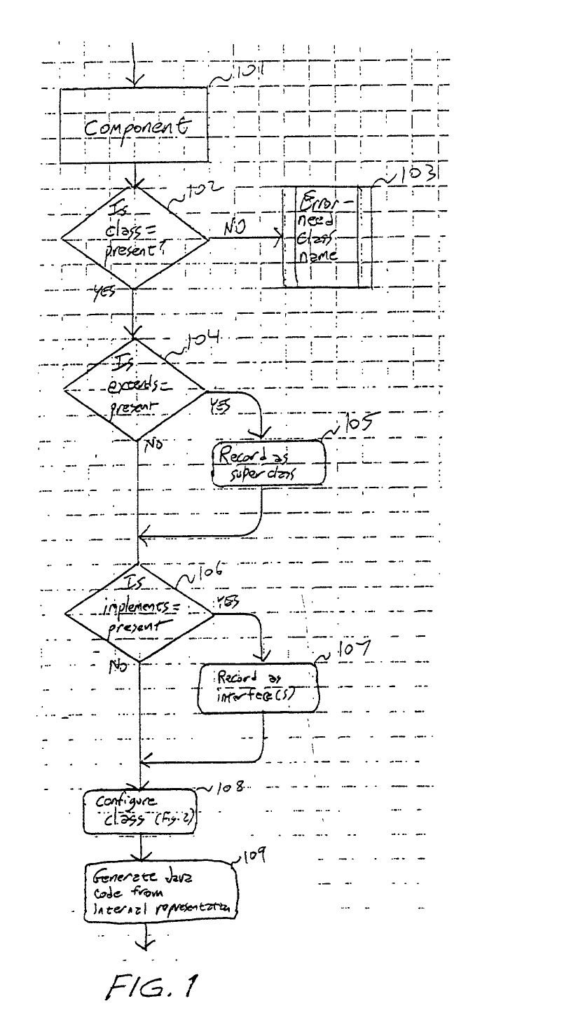

FIG. 1 is a flow chart illustrating the semantics of the <component> element. In step 101, a “component” is invoked to define a new bean. In decision step 102, a test is made to determine if the “class” attribute, which specifies the fully-qualified class name for this bean, is present. If so, the class name (and package name, if specified) are recorded for use during code generation; if not, an error is reported and the compiler stops, as shown in step 103.

Next, a test is made in decision step 104 to determine if the “extends” attribute, which provides the fully-qualified class name of the superclass that this bean extends, is present. If so, the superclass' name is recorded for use during code generation; if not, the bean's only superclass will be the default Java Object.

Similarly, a test is made in decision step 106 to determine whether the “implements” attribute is present. If so, its contents will be interpreted as a list of Java Interface names which this bean will implement, and those interface names will be recorded for use during code generation. As in the other attributes, the Interface names should be fully qualified, including their package name, if any. Not that this list is space-delimited, as is the convention in XML multiple-value attributes, rather than comma-delimited as in Java's corresponding keyword.

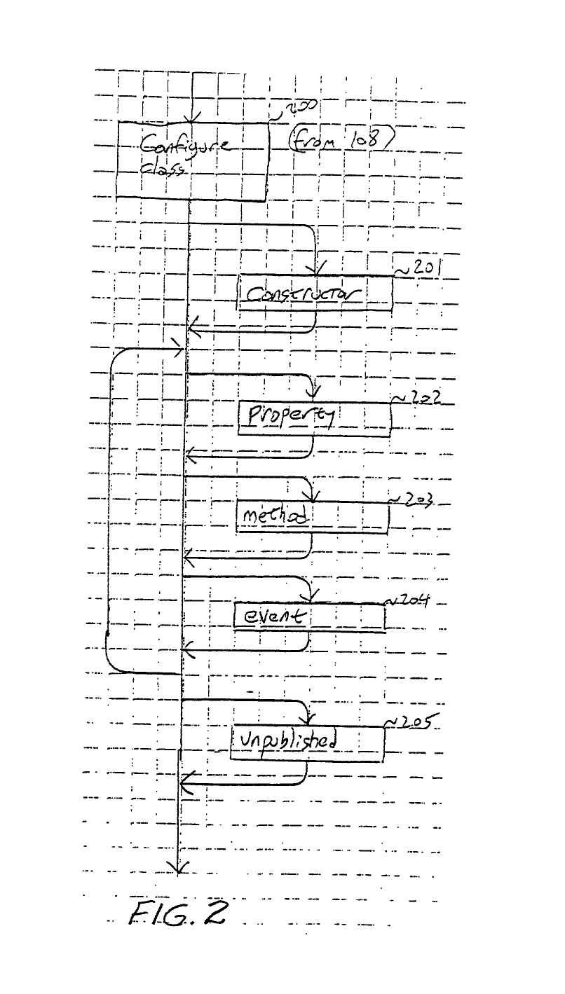

Now that the fundamental declaration of the bean's class has been determined, we invoke the “configure class” function block 108 to scan the contents of the <bsc:component> element and determine the bean's members and internal behaviors, as well be described with reference to FIG. 2. Finally, in step 109, we use the information obtained and deduced in steps 101 to 108 to generate the corresponding Java code required to implement a bean class—and, if necessary, an accompanying BeanInfo—matching this BSC description.

FIG. 2 is a flow chart expanding the “configure class” function block (function block 108) of the flow chart of FIG. 1. A <bsc:component> may optionally contain one or more “constructor”, “property”, “method”, “event”, or “unpublished” elements, as indicated in steps 201 to 205, respectively, and as will be discussed in further detail later in the specification.

Syntax:

<bsc:component class= “name-of-class-to-define”

[extends= “name-of-class-to-extend”]
[implements=“space-separated-list-of-interface-names]>”

[<bsc:constructor>]
[<bsc:property>|<bsc:method>|<bsc:event>]*
[<bsc:unpublished>]

</bsc:component>

Semantics:

Define a class named “name-of-class-to-define”, which optionally extends the class “name-of-class-to-extend”. If the class is to implement any interfaces, they can be named in the “space-separated-list-of-interface-names”. A single no-args constructor can optionally be defined. The bean may also define any number and combination of properties, methods, and events. Finally, an “unpublished” section may be used to specify some features which BSC otherwise forbids; this forces the user to be aware when they may be stepping outside the constraints of the mean metaphor, but permits them to do if that is necessary to fully describe the behavior of the generated class.

Example:

<bsc:component class=“foo.Bar”/>, defines a component with the

fully-qualified class name of “foo.Bar”, and generates the following code:

package foo;
public Class Bar
{
}

### The Constructor

In keeping with the JavaBeans specification, a public no-args constructor can be defined using a <bsc:constructor> element. If a user wishes to define a different type of constructor, a <bsc:method> element should be used. If a <bsc:constructor> element is not provided, no constructor is defined.

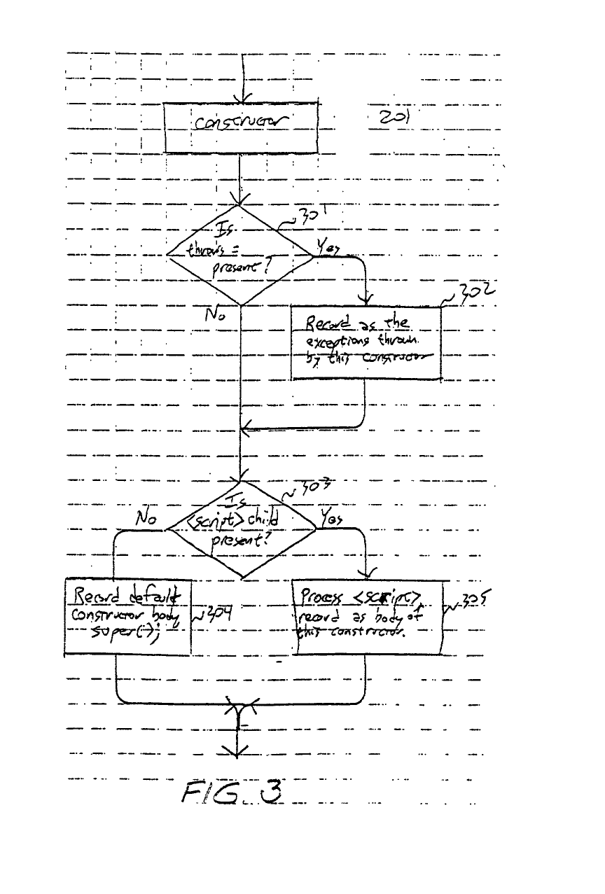

FIG. 3 is a flow chart illustrating the semantics of the <constructor> element of the flow chart of FIG. 2. In decision step 301, a test is made to determine if one or more exceptions may be thrown by the constructor 201 being defined. If yes, the “throws” attribute provides a space-delimited list of fully-qualified exception class names, which is recorded for use during code genration.

Next, a test is made in decision step 303 to determine whether a <bsc:script> child is present. If so, that script will be invoked as the body of the constructor 201, as indicated in step 304. If no script is provided, the default constructor behavior will be used, as indicated in step 305.

Syntax:

<bsc:constructor [throws=“space-separated-list-of-class-names”></bsc:script>]

</bsc:constructor>

Semantics:

The class defined by the parent <bsc:component> of a <bsc:constructor> will have a no-args constructor whose body is optionally defined by a child <bsc:script> element. A <bsc:constructor> can optionally specify which exceptions it throws via a “space-separated-list-of-class-names”. If the <bsc:constructor> does not contain a <bsc:script>, then a body will be generated that just invokes super( ) and returns.

Example:

<bsc:component class=“foo.Bar”>

<bsc:constructor>

<bsc:script language= “netrexx”>
....
</bsc:script>

</bsc:constructor>

</bsc:component>
generates the following code:
package foo;

public class Bar()
{

public Bar()
{
........ code to execute script ........
}

}

### Properties

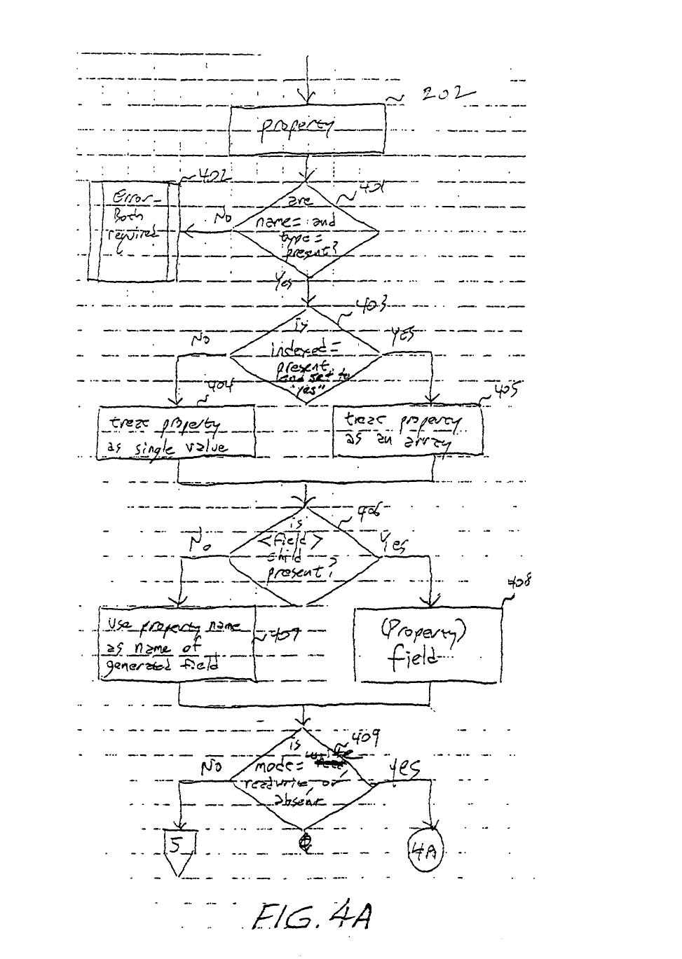

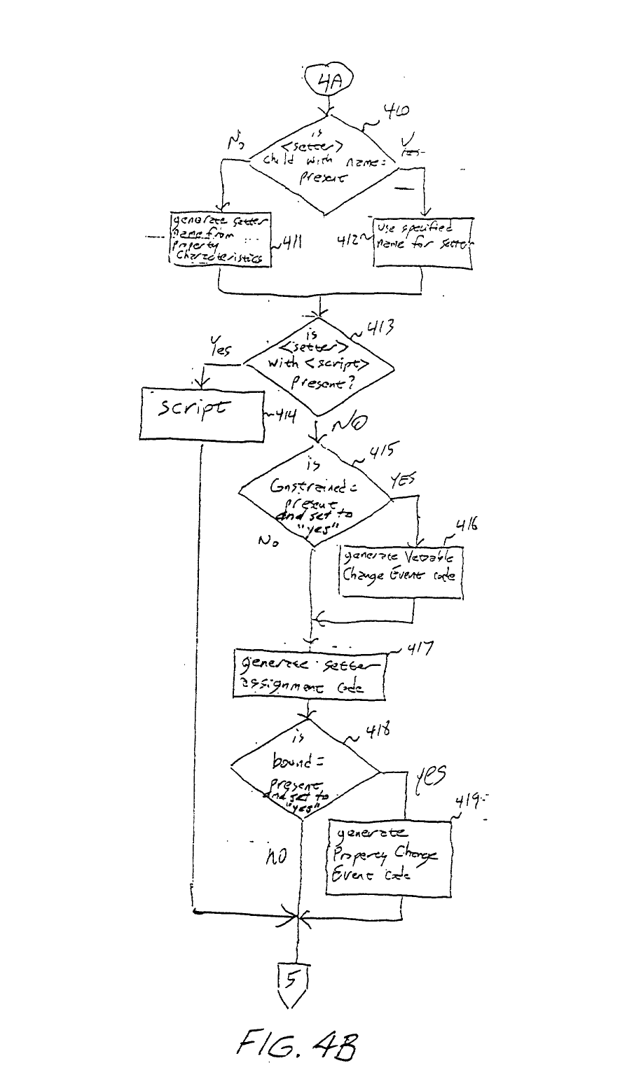

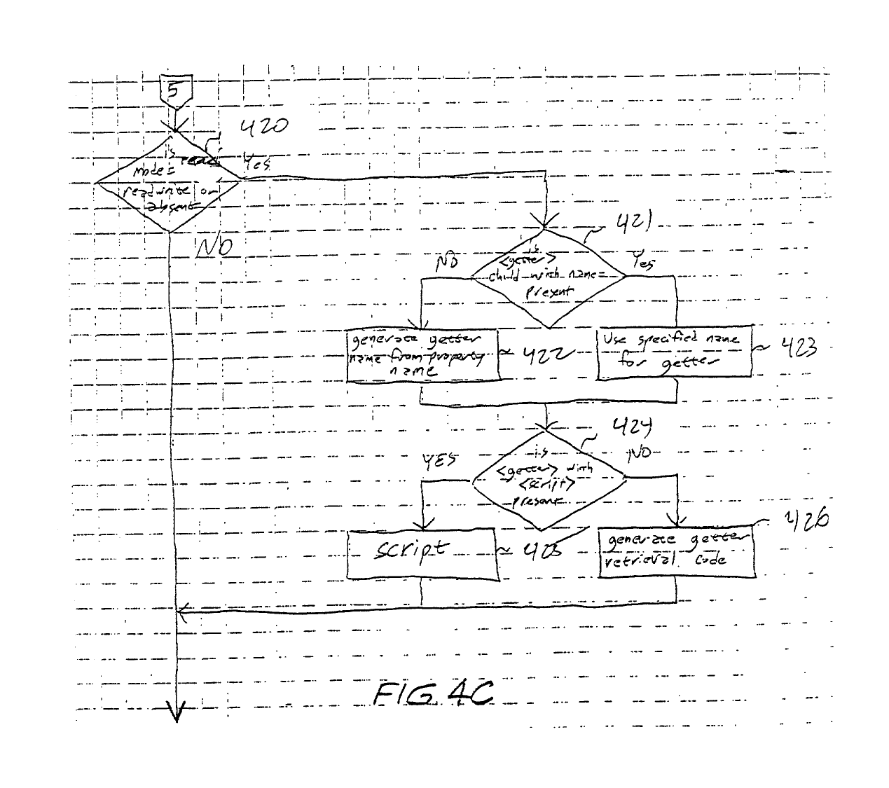

The <bsc:property> element is used to define a property (in the Java Beans sense) of its parent <bsc:component>. FIGS. 4A to 4C, taken together, are a flow chart illustrating the semantics of the <bsc:property> element of the flow chart of FIG. 2. As shown in decision step 401, a test is made to ensure that the “name” and “type” of the “property” element 202 are present. If they are not present, an error is returned, as indicated in step 402, and processing of this element stops.

Next, a test is made in decision block 403 to determine if the “indexed” attribute is present and set to “yes”. If so, the property 202 is treated as an array as shown in step 405 (per the Java Beans definition of indexed properties); if not, it represents a single value as show in step 404.

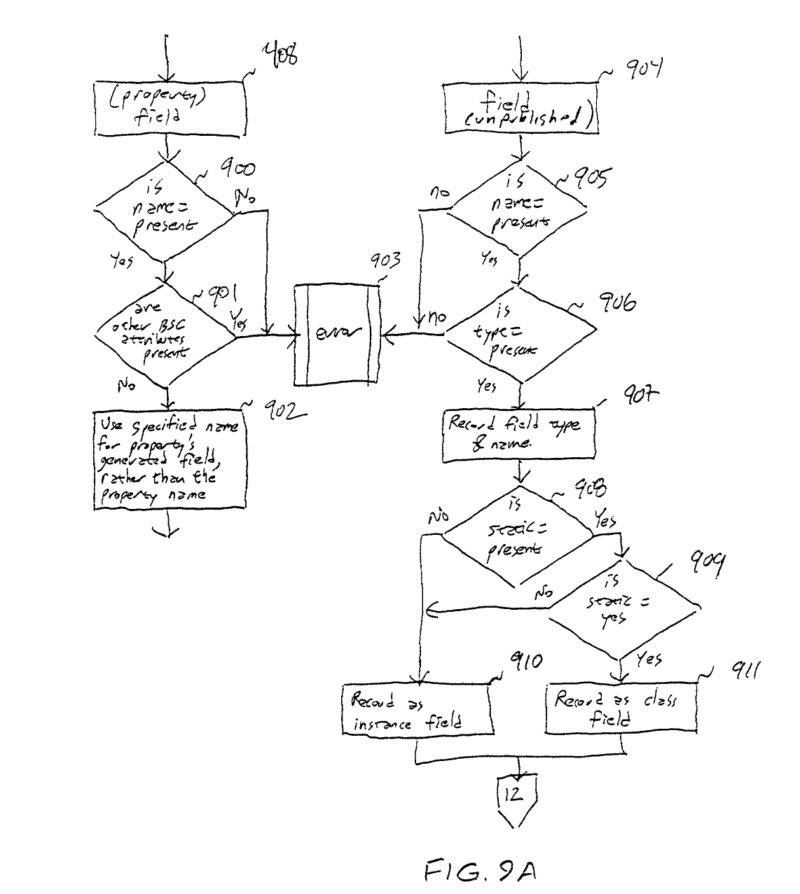

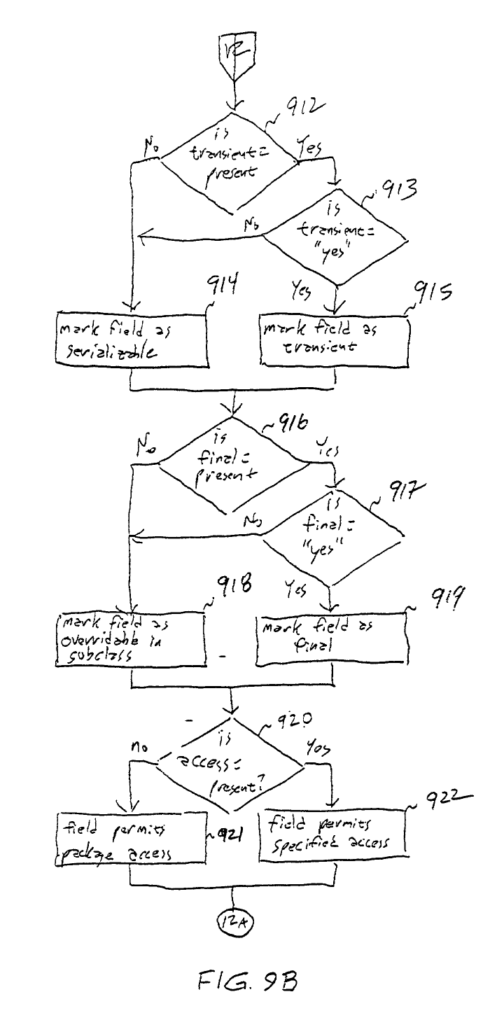

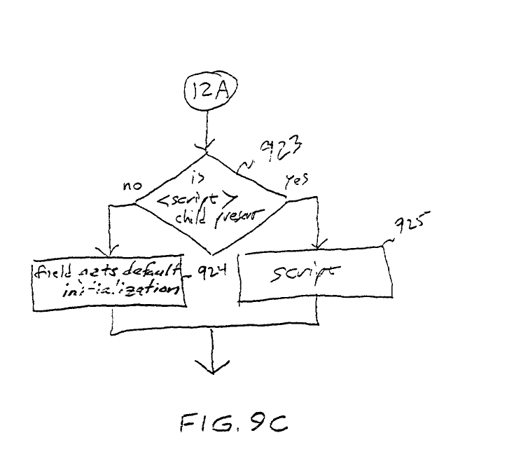

In decision step 406, we test whether the <bsc:property> has a <bsc:field> child element. If so, that will be examined to obtain additional information about the field (instance variable) generated in the Java code to hold the value of this property; see step 408 in FIG. 9. If no <bsc:field> was provided, the field variable will be synthesized with a set of default characteristics, and given the same name as the property as shown in step 407.

In decision step 409, we examine the property's “mode” attribute to determine whether or not to permit write access to this property. If the mode is unspecified, or has the values “write” or “read-write”, we begin gathering additional details that will be used to generate the setter method. This begins in step 410, where we check whether the <bsc:property> has a <bsc:setter> child element with a “name” attribute. If so, that name will be assigned to the setter method in step 412 (which may require generating a BeanInfo class to document this mapping); if not, the method name is generated in step 411 by capitalizing the first letter of the property name and prefixing “set” to the result, as per Java Beans conventions.

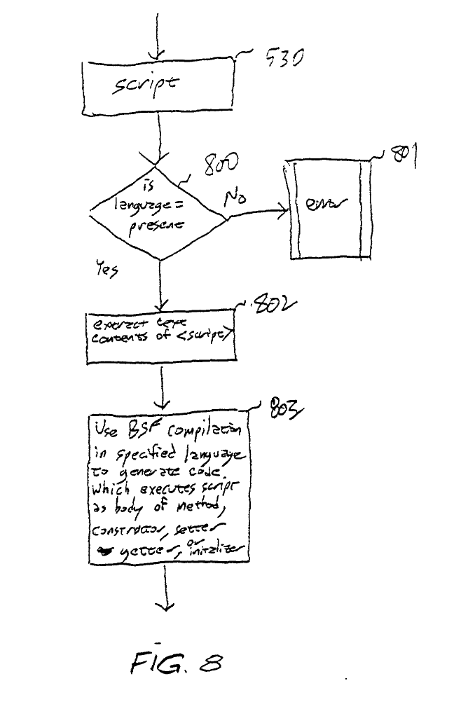

In decision step 413, we determine whether a method body has been provided by the BSC file's author. If present, the body will be contained by a <bsc:script> element within the <bsc:setter> child mentioned above, which is processed in step 414 and FIG. 8. Otherwise, we proceed to synthesize a basic setter method. This begins in decision step 415, where we check whther the “constrained” attribute of the <bsc:property> is present and set to “yes”. If so, block 416 causes the generated method body to begin with standard Java logic that transmits VetoableChangeEvents for this property and responds to vetos from listeners; it will also ensure that the method and field allowing those VetoableChangeListeners to register themselves with this component is created. In block 417, the appropriate assignment statement is added to the method body to copy the setter's parameter (the new value) to the prpoertyu field. Then, in decision step 418, we test whether the “bound” attribute of the <bsc:propertry> is present and set to “yes”; if so, block 419 causes the generated method body to end with standard Java logic that transmits PropertyChangeEvents for this property, and ensures that the method and field allowing those PropertyChangeListeners to register themselves with this component is created.

After the setter method has been generated in steps 410 to 419 or has been suppressed in step 409, we check the <bsc:property>'s “mode” attribute again in step 420. If it is absent or has the values “read” or “read-write”, we proceed to step 421 to begin generating a getter method for this property. This process is vary similar to that of generating the setter method, although simpler since no events will ever be transmitted. In step 421, we check whether the <bsc:property> has a <bsc:getter> child element with a “name” attribute. If so, that name will be assigned to the getter method in step 423 (which may require generating a BeanInfo class to document this mapping); if not, the method name is generated in step 422 by capitalizing the first letter of the property name and prefixing “set” to the result, as per Java Beans conventions. Then, in decision step 424, we determine whether a method will be contained by a <bsc:script> element within the <bsc:getter> child mentioned above, which is processed in step 425 and FIG. 8. Otherwise, we proceed to synthesize a basic getter method, which merely returns the value of this property's field.

This ends processing of the <bsc:property> element, and control returns to the loop in FIG. 2.

Syntax:

<bsc:property name= “name-of-property-to-define”

type= “type-of-property”
[indexed= “yes”]
[bound=“yes”]
[constrained=“yes”]
[mode= “read | write | read-write”]>

[<bsc:setter>]
[<bsc:getter>]
[<bsc:field>]

</bsc:property>

Semantics:

Define a property named “name-of-property-to-define”, of the type “type-of-property”. By default, a field and the appropriate accessors (based on the mode) are generated which follow the JavaBeans naming conventions. The user can override one or both the default accessors by defining a <bsc:setter> and/or a <bsc:getter>. In addition, the default field can be overridden by defining a <bsc:field>. The property can optionally be indexed, bound, and/or constrained. It can also be defined to be read-only, write-only, or readable and writable; restricting access via the mode attribute will suppress the getter or setter method, as appropriate. By default, a property will be neither indexed, nor bound, nor constrained, and will be both readable and writable.

Example:

<bsc:component class=“foo.Bar”>

<bsc:property name=“potato” type= “java.lang.String”

mode=“read”/>

<bsc:property name= “avocadoCount” type= “int”/>

</bsc:component>
generates the following code:
package foo;
public class Bar
{

private java.lang.String potato;
private int avocadoCount;
public java.lang.String getPotato()
{

return potato;

}
public int getAvocadoCount()
{

return avocadoCount;

}
public void setAvocadoCount (int avocadoCount)
{

this.avocadoCount = avocadoCount;

}

}

The “Bar” class defines a read-only property named “potato”, and a read/write property named “avocadoCount”. For an example of defining a <bsc:field> as the child of a <bsc:property>, see the section describing <bsc:field>.

### Setters and Getters

The <bsc:setter> and/or <bsc:getter> elements are used when the user wishes to override one of or both of the default set/get accessors which are generated by the parent <bsc:property>.

Syntax:

<bsc:setter [name= “name-of-setter-method-to-define”]>

[<bsc:script>]

</bsc:setter>
and/or
<bsc:getter [name= “name-of-getter-method-to-define”]>

[<bsc:script>]

</bsc:getter>

Semantics:

Override the default accessor, and optionally define the body of the method via the child <bsc:script>. An arbitrary method name can be specified for the accessor via the optional name attribute. If the <bsc:setter> or <bsc:getter> does not contain a <bsc:script>, then the standard default method body will be generated which simply assigns to, or retrieves th value of, the property's field.

Example:

<bsc:component class=“foo.Bar”>

<bsc:property type=“int” name= “avocadoCount”>

<bsc:getter name= “giveMeAvocadoCount”>

<bsc:script language= “javascript”>

.......

</bsc:script>

</bsc:getter>

</bsc:property>

</bsc:component>
generates the following code:
package foo;
public class Bar
{

private int avocadoCount;
public mt giveMeAvocadoCount()
{

.... code to execute script ...

}
public void setAvocadoCount (int avocadoCount)
{

this.avocadoCount = avocadoCount;

}

}

The “Bar” class defines a property named “avocadoCount” which is both readable and writable. The getter method of the “avocadoCount” property is named “giveMeAvocadoCount”, and the body of the method is defined in the scripting language javascript. The “avocadoCount” field and the default setter method are still generated. Note that if all relevant accessors are overridden (i.e., define a <bsc:getter> if readable, a <bsc:setter> if writable, and both if readable and writable), the default field will not be generated. If a field declaration is desired in that case, then a <bsc:field> element child of the <bsc:property> should be used.

A Beaninfo class must also be generated in this case to fully define that the read method of the avocadoCount property is named “giveMeAvocadoCount”.

### Methods

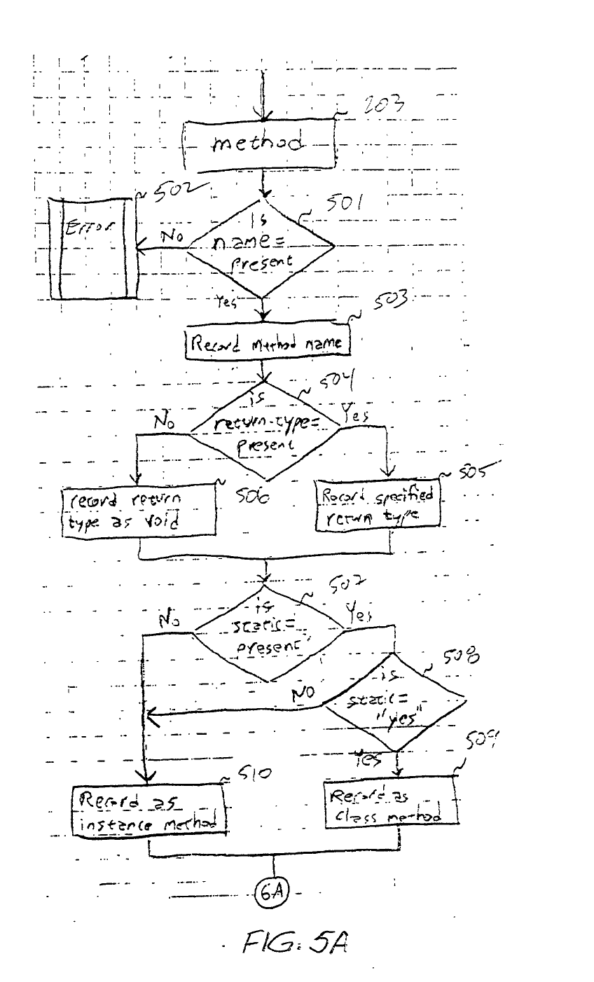

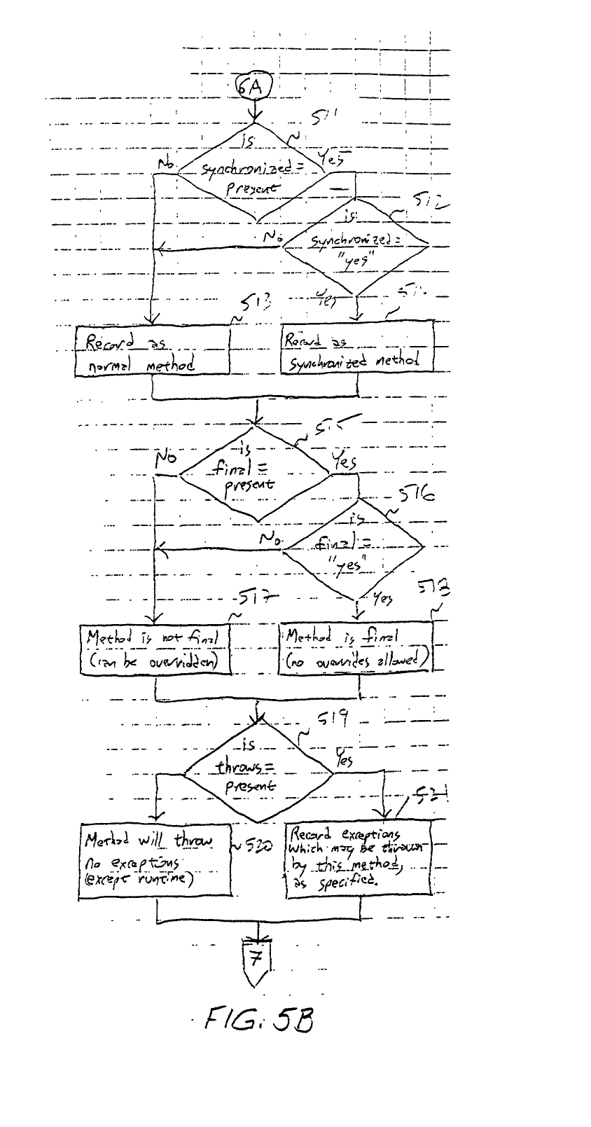

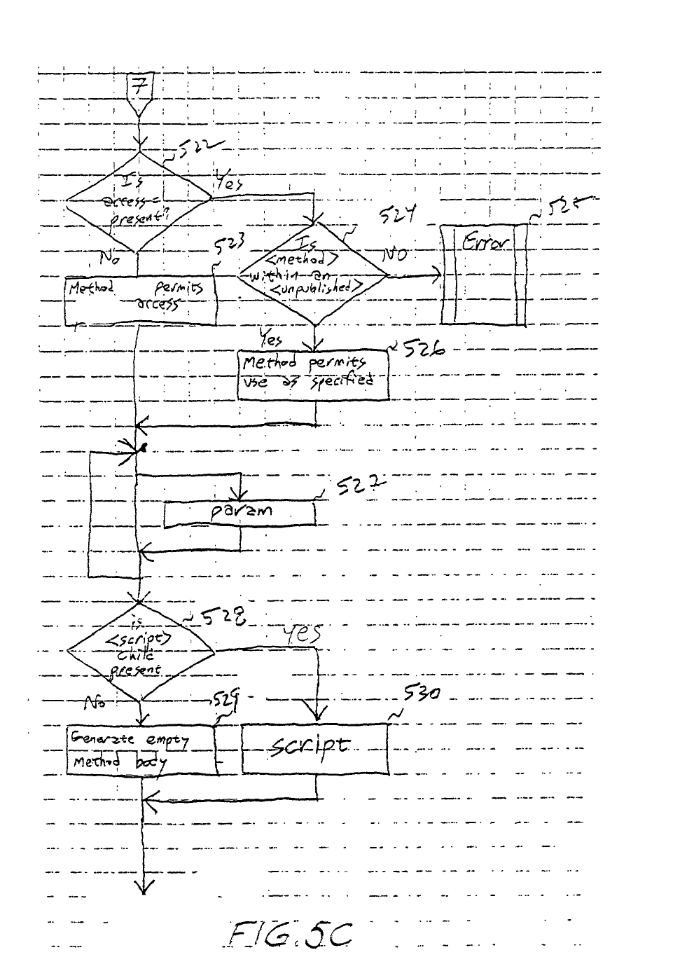

The <bsc:method> element is used to define a method of the parent <bsc:component>. FIGS. 5A to 5C, taken together, are a flow chart illustrating the semantics of the <bsc:method> element of the flow chart of FIG. 2. In decision step 501, a test is made to determine if a “name” is present for the <bsc:method> element 203. If a name is not present, an error is returned, as indicated in step 502; otherwise, the value of this attribute will be used as the name of the generated Java method, as indicated in step 503.

In decision step 504, a test is made to determine whether the “return-type” attribute has been specified for the <bsc:method> being processed. If so, its value—the fully qualified name of the datatype which this method will return—is stored in step 505 for use during code generation. If the return-type was not specified, BSC assumes that the method will not return a vaule (or, in Java terms, the “void” type), as indicated in step 506.

In decision steps 507 and 508, a test is made to determine whether the “static” attribute is present and has the value “yes”. If so, the generated Java method will include the “static” keyword and describe a static (class) method, as shown in step 509; otherwise, we will leave that keyword out and generate an instance method, as shown in step 510.

Similarly, in decision steps 511 and 512, we determine whether the “synchronized” attribute is present and contains the value “yes”. If so, the generated Java method will be declared using the “synchronized” keyword to manage potential multi-threading conflicts; this is shown in step 514. Otherwise, a “normal” non-synchronized Java method will be produced, as shown in step 513.

Again, in decision steps 515 and 516, we test whether the “final” attribute is present and set to “yes”. This controls whether the Java method is generated (in step 518) or without (in step 517) the “final” keyword, which constrains method overloading should a subclass of the Bean be written.

In decision step 519, a test is made to determine whether the “throws” attribute is present. If so, it will contain a space-delimited list of fully qualified classnames, which will be used to declare the exception classes that this method may throw, as shown in step 521. If “throws” is not specified, the method will not throw any exceptions other than Runtime Exceptions and Errors, as shown in step 520.

Decision step 522 tests whether the “access” attribute hs been specified. If so, it will contain an access control keyword (public, protected, private, package) specifying who is allowed to invoke this method. Since the Java Beans coding conventions consider only public methods, this attribute is permitted only on <bsc:method> elements that appear within a <bsc:unpublished> element; this is tested in decision step 524 before accepting and recording the keyword in step 526, while violations of this policy are reported as errors in step 525. If an access policy is not specified, we assume that this is intended to be a Bean Method and default to permitting public access; this is shown in step 543.

A <bsc:method> element may optionally contain one or more <bsc:param> elements, which specify the formal parameters passed to this method. If present, they are processed in step 527. It may also optionally specify code to be invoked as the method body, by containing a <bsc:script> element; this is searched for in decision step 528 and (if present) processed in step 530 in FIG. 8. If no explicit method body is provided, an empty (no-op) body will be generated, as shown in step 529.

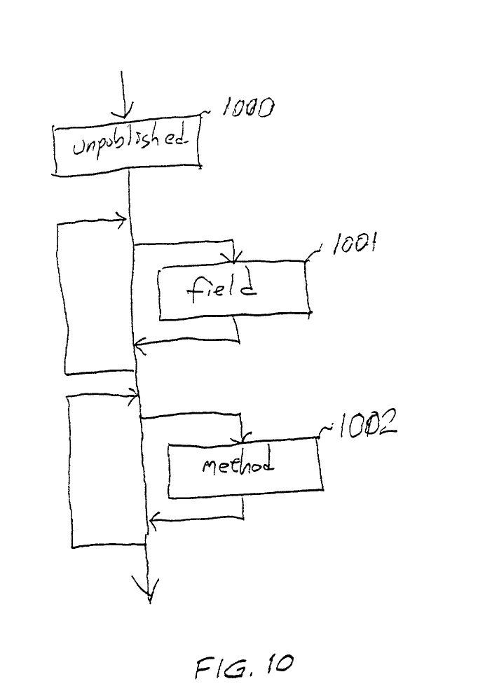

This completes prcessing of the <bsc:method> element, and control returns either to thepoint which invoked this code—either the loop in FIG. 2, or the similar loop in FIG. 10, as appropriate.

Syntax:

<bsc:method name= “name-of-method-to-define”

[return-type= “name-of-return-type”]
[access= “package | public | protected | private”]
[static= “yes”]
[synchronized= “yes”]

[throws= “space-separated-list-of-class-names”

[<bsc:param>]*
[<bsc:script>]

</bsc:method>

Semantics:

Define a method named “name-of-method-to-define”, whose return type is “name-of-return-type”. The “name-of-return-type” default is “void”. When the <bsc:method> is a direct child of the <bsc:component>, the access attribute is not allowed. However, it is allowed when the <bsc:method> is contained within the <bsc:unpublished> element. The allowable values for the access attribute are: “package”, “public”, “protected”, and “private” (the value “Package” indicates that no access modifier will be generated and that the method has Java's package level access). The user may also optionally specify any combination of the following modifiers by including them as attributes and setting their values equal to “yes” “static”, “synchronized”, and “final”. By default, the only modifier that will be applied to the method is the access modifier “public”. Parameters can optionally be specified via child <bsc:param> elements, and a <bsc:method> can optionally specify which exceptions it throws via a “space-separated-list-of-class-names”. The body of the method can optionally be defined via a child <bsc:script>. If the <bsc:method> does not contain a <bsc:script>, then a method stub will be created with an empty body.

Example:

<bsc:component class= “foo.Bar”>

<bsc:method name= “launchPotato” synchronized=“yes”>

<bsc:script language= “lotusscript”>
.......
</bsc:script>

</bsc:method>

</bsc:component>
generates the following code:
package foo;
public class Bar
{

public synchronized void launchPotato()
{
.. code to execute script ...
}

}

The “Bar” class defines a public method named “launchPotato”. The “launchpotato” method has a return type of void, is synchronized, takes no arguments, and has a body defined by some script.

### Parameters

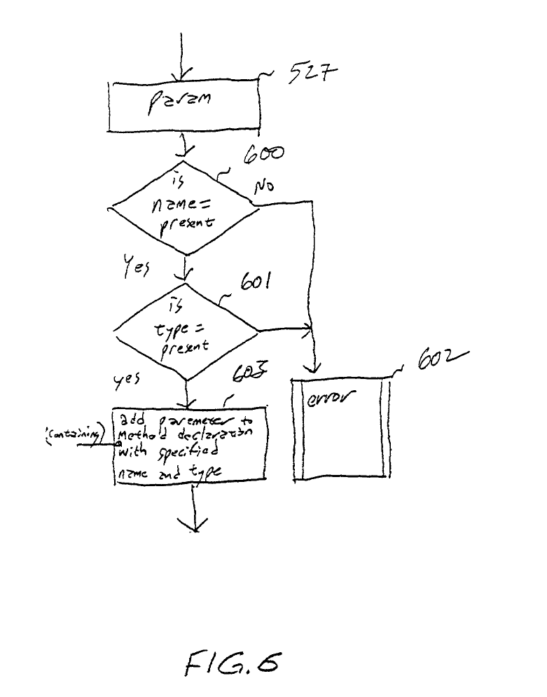

The <bsc:param> element is used to define a parameter of the parent <bsc:method>. FIG. 6 is a flow chart illustrating the semantics of this element, and is invoked by the loop in the flowchart of FIG. 5.

Decision step 600 tests that the <bsc:param> has the required “name” attribute. If not, an error is returned, as indicated in step 602; if it is available, the value will become the parameter's name, as shown in step 601. Similarly, decision step 603 tests that the required “type” attribute is present; if so, its value provides the fully qualified datatype for this parameter, as shown in step 603, while its absence is reported as an error, as shown in step 304. Processing then returns to the flowchart for the <bsc:method> to check for additional parameters and/or a method body.

Syntax:

<bsc:param name=“name-of-parameter-to-define” type=“name-of-parameter-type”/>

Semantics:

Define a parameter named “name-of-parameter-to-define” to the parent <bsc:method> of type “name-of-parameter-type”. The Java parameters will be declared in the same order as their corresponding <bsc:param> elements.

Example:

<bsc:component class=“foo.Bar”>

<bsc:method name=“launchPotato”>

<bsc:param type=“float” name= “velocity”/>
<bsc:param type=“foo.launcher.Angle” name= “incline”/>
<bsc:script language=“jpython”>
...
</bsc:script>

</bsc:method>

</bsc:component>
generates the following code:
package foo;
public class Bar
{

public void launchPotato(float velocity, foo.launcher.Angle

incline)
{

... code to execute script ...

}

}

The “Bar” class defines a public method named “launchPotato”. The “launch Potato” method has a return type of “void”, takes two arguments, and has a body defined by some script. Note that method parameters are accessed within a script in a language-dependent manner.

### Events

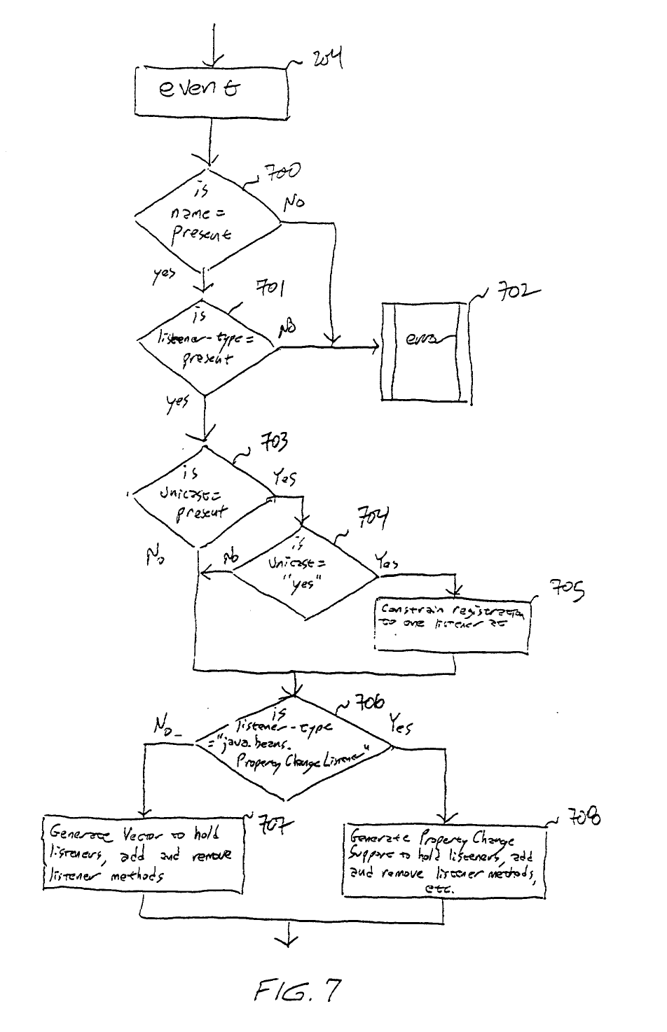

The <bsc:event> element is used to define events that the parent <bsc:component> will fire. FIG. 7 is a flow chart illustrating the semantics of the <bsc:event> element of the flow chart of FIG. 2. In decision step 700, a test is made to determine if the required “name” attribute is pr4esent, whose value provides the name of the event. In decision step 701, a similar test is made for the required “listener-type” attribute, which provides the class name for the Listener objects to which this event will be dispatched. If either is missing, an error is returned, as indicated in step 702.

In decision steps 703 and 704, tests are made to determine whether the “unicast” attribute is present and has the value “yes”. If so, we are defining a Java Beans unicast event, for which only one listener may be registered at a time, as shown in step 705; if not, multiple simultaneous listeners may be registered as once. This affects the fields and methods generated to support event registration and distribution.

In decision step 706, we test for the special case where thelistener type is “java.beans.PropertyChangeListener”. If so, we take advantage of the standardized java.beans.PropertyChangeSupport class to simplify implemenation of this even and implement the even support methods in terms of it, as shown in step 708. Otherwise, we must construct these methods from first principles; our current implementation creates a java.lang.Vector field within the bean to maintain the list of active listeners, as shown in step 708.

We now have the data required to build support code for this event, and BSC compilation returns to the loop in FIG. 2.

Syntax:

<bsc:event name=“name-of-event-to-define” listener-type=“name-of-type-of-event-listener” [unicast=“Yes “]/>

Semantics:

The parent <bsc:component> will fire an event named “name-of-event-to-define”, and will accept objects which are instances of “name-of-type-of-event-listener” as listeners for this event. A vector is created to hold listeners, and methods are generated to add/remove listeners to/from this vector. If unicast=“yes” is requested, only one listener may be registered for this event at a time; otherwise any number of listeners may be registered simultaneously.

Example:

<bsc:component class=′foo.Bar′>

<bsc:event name=″potato″ listener-type=″foo.VegetableListener″/>

</bsc:component>
generates the following code:
package foo;
public class Bar
{

java.util.Vector potatoListeners = new java.util.Vector();
public void addPotatoListener(foo.VegetableListener l)
{

potatoListeners.addElement(l);

}
public void removePotatoListener(foo.VegetableListener l)
{

potatoListeners.removeElement(l);
}

}

The “Bar” class fires an event named “potato”, and is capable of delivering this event to “vegetableListener” objects.

### Scripts

The <bsc:script> element is used to define the body of a parent <bsc:constructor>, <bsc:getter>, <bsc:setter>, or <bsc:method>, or to define the initializer expression of a parent <bsc:field>. FIG. 8 is a flow chart illustrating the semantics of the <bsc:script> element of the flow chart of FIGS. 3 and 5. In decision step 800, we check whether the name of the scripting language has been specified via the “name” attribute. If not, an error is returned, as indicated in step 801. Otherwise, the text contained within the <bsc:script> element is extracted in step 802, and a Bean Scripting Framework (BSF) compilation is performed in step 803 to yield Java source code which will execute this text as a script written in the specified language. This generated Java code will then be used to build the body of the constructor or method currently being compiled.

Syntax:

<bsc:script language ″name-of-scripting-language″>

<![CDATA[... ]]>

<bsc:script>

Semantics:

Define a script in the language “name-of-scripting-language”, whose literal value is described by the characters contained within the <bsc:script> element. The value of the language attribute can be any language supported by the Bean Scripting Framework (BSF).

If a script returns a value, that value must be either castable to the type of the property/field/return-value which will receive it, or (if the destination is a Java primitive datatype) must be the standard Java.lang wrapper class for that primitive type.

While shown here as a CDATA Section (which will probably be the most common approach, as it suppresses much of the risk that script language syntax might conflict with XML syntax), the <bsc:script> element may contain any mixture of Text children. This may be required if, for example, the enclosed script wishes to refer to the “]]>” string, or reference an entity, neither of which can be expressed entirely within a single CDATA Section. It may also be convenient if the script body does not require escaping, as shown below.

Example:

<bsc:component class=″foo.Bar″>

<bsc:method name=″launch Potato″>

<bsc:param type= ″float″ name=″velocity″/>
<bsc:param type=″foo.launcher.Angle″ name=″incline″/>
<bsc:script language=″jacl″>

$externalComponent initiateLaunch velocity incline

</bsc:script>

</bsc:method>

</bsc:component>
generates the following code:
package foo;
public class Bar
{

public void launchPotato(float velocity, foolauncher.Angle incline)
{
... code to execute script
}

}

The “Bar” class defines a public method named “launchPotato”. The “launchpotato” method has a return type of void, takes two arguments, and has a body defined by some Jac1 code.

### Fields

The <bsc:field> element is used to define a field in the class being created. Since fields are not part of the official Java Beans API (application program interface) conventions, they may only be defined within <bsc:property> elements—where they override the name of the default field, which provides a place to store the property's value—or within the <bsc:unpublished> element, which describes details of the component not directly exposed through the Java Bean conventions. FIGS. 9A to 9C show two separate logic paths for processing the <bsc:field> element, corresponding to these two cases.

The first logic path is a flow chart expanding on the “property field” function block 408 in FIG. 4. In this usage, most of the field's characteristics are derived from those of the enclosing <bsc:property>, and in fact only the field name may—and must—be overridden. In decision step 900, we chack whether the “name” attribute which provides this value has been specified on the <bsc:field> element; if not, we return an error in step 903. In decision step 901, we test whether the user has tried to use BSC's attributes to alter any of the field's other characteristics; if so, this too returns an error via step 903. Once both these tests are passed, the specified field name is used instead of the default (which would be to give the field the same name as the property it represents, in step 407). This completes processing of the <bsc:field> element, and control is returned to function block 408 and proceeds with block 409 in FIG. 4.

The second logic path is a flow chart expanding on the “unpublished field” function block 1001 in FIG. 10. In this case, the <bsc:field> must minimally include the “name” attribute (whose presence is tested in decision block 905) and the “type” attribute (which is similarly tested in decision step 906). If either is missing, an error is reported in step 903; otherwise, they provide the name and data type of the Java variable, respectively, as shown in step 907.

We then proceed to check for modifiers to this field. Decision blocks 908 and 909 test whether the “static” attribute is present and has the value “yes”, respectively. If both tests succeed, we will produce a static (class) field in the Java code, as shown in block 911; otherwise, we are defining an instance field, as shown in block 910.

Decision blocks 912 and 913 test whether the “transient” attribute is present and has the value “yes”, respectively. If both tests succeed, the “transient” keyword is added to the Java declaration for this field, as shown in block 915; this indicates that the field need not be retained when the object is serialized for storage or transmission. Otherwise, the field is one that should be retained by the serialization/deserialization process, as shown in block 914.

Decision blocks 916 and 917 test whether the “final” attribute is present and has the value “yes”, respectively. If both tests succeed, then as shown in block 919, this field will be marked as “final”, meaning that the compiler should not permit it to be redefined in subclasses of this component. Otherwise, the field may be overridden in subclasses, as shown in block 918.

Decision block 920 tests whether the “access” attribute is present. If so, its value (which must be one of “protected”, “private”, “package” or “public”) specifies what access permissions are granted on this field, as shown in step 922. If “access” is not specified, fields default to permitting package access, as shown in step 921; this corresponds to Java's default behavior.

Finally, decision step 923 tests whether the <bsc:field> element contains a <bsc:script> child element. If so, that element is interpreted to yield a Java expression, which will be used as the field's initializer; this is shown in step 925, which refernces FIG. 8. If no <bsc:script> is specified, the field will be given a default initialization, as shown in step 924.

This completes processing of the “unpublished field” case, and control returns to the loop in FIG. 10.

Syntax:

<bsc:field name=′name-of-field-to-define″

type=″type-of-field″
[access=″package[public | protected | private″]
[static=″yes″]
[transient=″yes″]
[final=″yes″>

[>bsc:script>]

</bsc:field>

Semantics:

Define a field named “name-of-field-to-define”, of the type “type-of-field”. When the <bsc:field> is a direct child of a <bsc:property>, the only allowable attribute is name. However, all attributes are allowed when the <bsc:field> is contained within the <bsc:unpublished> element The allowable values for the access attribute are: “package”, “public”, “protected”, and “private” (the value “package” indicates that no access modifier will be generated). Note that property fields will always be declaredc with the “private” access modifier, while “unpublished” fields will default to package access if not instructed otherwise. The user can also optionally specify any combination of the following modifiers by including them as attributes and setting their values equal to “yes”: “static”, “transient”, and “final”. An initializer expression can optionally be specified via a child <bsc:script>. If a <bsc:field> does not contain a <bsc:script>, then the Java default initial value for a class-level variable of the type “type-of-field” will be used (e.g., an object reference will be null, and an int will be 0).

Example:

<bsc:component class=″foo.Bar′>

<bsc:property name=″avocadoCount″type=″int″>

<bsc:field name=″numberOfAvocados″/>

</bsc:property>

</bsc:component>
generates the following code:
package foo;
public class Bar
{

private int numberOfAvocados;
public int getAvocadoCount()
{

return numberOfAvocados;

}
public void setAvocadoCount(int avocadoCount)
{

numberOfAvocados = avocadoCount;

}

}

The “Bar” class defines a property named “avocadoCount” which is both readable and writable, and a private field named “numberOfAvocados”. The generated accessor methods will use the “numberOfAvocados” field to store its state.

### Non-Bean Fields and Methods

The <bsc:unpublished> element is used to contain the parts of the bean that are not explicitly exposed as parts of its bean interface. This allows BSC to describe “supporting” fields and methods, which are often required to complete the practical implementation of a working Java Bean.

FIG. 10 is a flow chart illustrating the semantics of the <bsc:unpublished> element of FIG. 2. This element can contain any number of combination of <bsc:field >s 1001 and <bsc:method>s 1002 which will not be included in the BeanInfo which describes the component being created.

Syntax:

<bsc:unpublished>

[<bsc:field>]*
[<bsc:method>*
</bsc:unpublished>

Semantics:

Define a section to contain any number and combination of fields and methods which will not be returned by the BeanInfo which describes the bean being created, nor are required to honor the constraints of the Java Beans coding conventions. Within the <bsc:unpublished> element, the user can create additional fields of all varieties, non-public methods, and constructors which take arguments.

In the current instantiation of the language, a parameterized constructor is defined by a <bsc:method> element whose method name is the same as the name of the class (without the package qualifier) and no specified return type; alternatives such as an extended version of the <bsc:constructor> element are of course possible.

Example:

<bsc:component class=″foo.Bar″>

<bsc:unpublished>

<bsc:field name=″versionld type=″long″ access=″protected″ static=″yes″>

<bsc:script language=″vbscript″>

......

</bsc:script>

</bsc:field>
<bsc:method name=″mashPotato″ access=″private″>

<bsc:script language=″vbscript″>

......

</bsc:script>

</bsc:method>

</bsc:unpublished>

</bsc:component>

generates the following code:
package foo;
public class Bar
{

protected static long versionld = ... code to eval script ...;
private void method mash Potato()
{

... code to execute script

}

}

The “Bar” class defines two non-Bean features: a class (static) field called “versionld” which holds a long-integer value that may only be accessed by this class and its subclasses, and an instance method named “mashPotato” which takes no arguments and does not return a value.

Having thus described our invention, what we claim new and desire to secure by Letters Patent is as follows:

1. A Bean Scripting Component (BSC) language for defining and implementing components using a scripting language and that provides a syntax for describing a component's properties, events and methods, wherein a BSC document comprised of BSC components can be compiled into Java such that the component is compatible with Java.

2. A BSC language according to claim 2, wherein said BSC language is based on an eXtensible Markup Language (XML).

3. The BSC language according to claim 1, wherein the components are JavaBean components which describe a component's properties such that a JavaBean extends another class.

4. The BSC language according to claim 1, wherein the language describes a component's properties by implementing an interface to another class.

5. The BSC language according to claim 1, wherein the language describes a component's properties by implementing a no-argument constructor.

6. The BSC language according to claim 5, wherein the no-argument constructor specifies which exceptions it throws.

7. The BSC language according to claim 1, wherein a component utilizes a property element to define a property of its parent.

8. The BSC language according to claim 7, wherein the language optionally allows the property element to be indexed.

9. The BSC language according to claim 7, wherein the language optionally allows the property element to be bound.

10. The BSC language according to claim 7, wherein the language optionally allows the property element to be constrained.

11. The BSC language according to claim 7, wherein the language utilizes a setter element to override a set accessor generated by the parent.

12. The BSC language according to claim 7, wherein the language utilizes a getter element to override a get accessor generated by the parent.

13. The BSC language according to claim 1, wherein the language utilizes a method element to define a method of the parent component.

14. The BSC language according to claim 13, wherein the method element optionally provides access to at least one of a public method, a private method, a protected method, or a Java package.

15. The BSC language according to claim 13, wherein the method element provides a static modifier.

16. The BSC language according to claim 13, wherein the method element provides a synchronized modifier.

17. The BSC language according to claim 13, wherein the method element provides a final modifier.

18. The BSC language according to claim 13, wherein the method element provides a throws modifier.

19. The BSC language according to claim 13, wherein a parameter element is utilized to define a parameter of the parent method.

20. The BSC language according to claim 1, wherein the language utilizes an event element to define events that the parent component will fire.

21. The BSC language according to claim 20, wherein the language optionally allows only one listener to be registered for the event at a time.

22. The BSC language according to claim 1, wherein the language utilizes a script element to define a body of at least one of the parent constructor, getter, setter or method.

23. The BSC language according to claim 1, wherein the language utilizes a script element to define an initializer expression of a parent field.

24. The BSC language according to claim 1, wherein the language utilizes a field element to define a field in the class being created.

25. The BSC language according to claim 24, wherein the field element optionally provides access to at least one of a public method, a private method, a protected method, or a Java package.

26. The BSC language according to claim 24, wherein the field element provides a static modifier.

27. The BSC language according to claim 24, wherein the field element provides a static modifier.

28. The BSC language according to claim 24, wherein the field element provides a transient modifier.

29. The BSC language according to claim 24, wherein the field element provides a final modifier.

30. The BSC language according to claim 1, wherein an unpublished element is used to contain parts of the component that explicitly exposed as a part of the component interface.

31. The BSC language according to claim 30, wherein when an unpublished element is present, a BeanInfo class must be generated to correctly compile the component into a Java class.

32. The BSC language according to claim 30, wherein the BeanInfo class will be used to expose only those properties, methods and events that are outside of the unpublished element as the component's interface.
